(19) United States
(12) Patent Application Publication
(10) Pub. No.: US 2003/0028383 A1
(43) Pub. Date: Feb. 6, 2003

(54) System for modeling and simulating emotion states

(75) Inventors: Charles L. Guerin, Morin Heights (CA); Albert Mehrabian, Monterey, CA (US)

Correspondence Address: MERCHANT & GOULD PC, P.O. BOX 2903, MINNEAPOLIS, MN, 55402-0903, US

(73) Assignee: I & A Research Inc., St-Sauveur, QC (CA)

(21) Appl. No.: 10/081,822

(22) Filed: Feb. 20, 2002

Related U.S. Application Data
(60) Provisional application No. 60/269,348, filed on Feb. 20, 2001.

(51) Int. Cl. G10L 11/00

(52) U.S. Cl. 704/275

(57) ABSTRACT

The present invention, in its broadest expression, includes (a) the Pleasure-Arousal-Dominance (PAD) table of emotions that makes it possible (b) to convert emotion terms to their respective PAD values, (c) a formula for working back from any specific set of PAD values to derive a single emotion term that best fits that particular combination of PAD values, (d) a formula for calculating the distance between a preselected set of PAD values and the closest emotion term that matches those PAD values, (e) a method for calculating the average emotional response of a group to any situation or stimulus, thereby permitting the derivation of a single emotion term that best represents the average emotional experience of the group. (f), a generic procedure for deriving emotion terms from multidimensional statistical models. The present invention finds use as an emotion simulator, particularly in the field of closed and open loop systems, such as a heating system, in order to represent how the system is performing.

### FIELD OF THE INVENTION

The present invention relates generally to emotion simulators and more specifically it relates to a system for modeling and simulating emotion states of human (individual or group) emotion responses using data analysis of real-time or non-real time data.

### DESCRIPTION OF THE PRIOR ART

It can be appreciated that emotion simulators have been in use for years. Emotion simulators allow a computer to mimic human emotion by using some data model or algorithm to give the user of the software the impression that the software is acting in an emotional manner.

Typically, emotion simulators are comprised of categorical, logic-based systems that infer emotion labels based on a series of “if” statements or predicate rules (typically used in software adventure games), analogic systems that determine emotions by analogy (SME, Copycat, and ACME), neural net systems (Emotivate system) and the dimensional AVC (arousal-valence-control) Emotion Model.

The main problem with conventional emotion simulators is that their emotion representations work only in very specific situations, and do not provide a general solution for modeling emotion states or temperament (“temperament” is distinguished from emotion states in that it refers to an individual's stable or lasting emotional characteristics).

Another problem with conventional emotion simulators is that they require complex logic, provide limited environmental complexity, and provide outputs that are interpretive, at best. Another problem with conventional emotion simulators is that they do not provide mathematics for the analysis of the emotions of groups of individuals.

Known in the art is a PAD table of emotions, a small section of which is shown in FIG. 1, labeled as “Prior Art”. This table provides precise descriptions (or measures) of 320 of the most common emotion terms by referencing each emotion term to three fundamental dimensions of emotional response: pleasure-displeasure (P), arousal-nonarousal (A), dominance-submissiveness (D). The PAD table of emotions contains 320 rows of data and is a database of information consisting of four fields, as shown in FIG. 1. The first field is of String type and represents an emotion term (i.e., a label describing a specific emotion). The second field, labeled “P”, is numeric, with values that can range from −100 to +100, and indicates the degree of pleasure vs. displeasure that is associated with the emotion term given in the first field. The third field, labeled “A”, is numeric and can range from −100 to +100, and indicates the degree of arousal vs. nonarousal (defined as a combination of mental alertness and physical activity of an individual) that is associated with the emotion term given in the first field. The fourth field, labeled “D”, is numeric and can range from −100 to +100, and indicates the degree of dominance vs. submissiveness (defined as the feeling of control vs. lack of control an individual subjectively experiences) that is associated with the emotion term given in the first field.

The basic experimental rationale for describing and measuring all possible human emotions in terms of the three basic emotion dimensions of pleasure-displeasure (P), arousal-nonarousal (A), and dominance-submissiveness (D) were first described by Mehrabian and Russell (1974). Mehrabian (1995) detailed the historical development of the PAD approach, its evolution, and more specifically, the evolution of the psychometric procedures used to measure P, A, and D values for each emotion.

Many of the technical terms used in the present description are defined by Dr. Albert Mehrabian, in his book “Basic dimensions for a general psychological theory: Implications for personality, social, environmental, and developmental studies”, published by Oelgeschlager, Gunn & Hain, Cambridge, Mass. in 1980, which book is incorporated herein by reference.

Many of the software-related terms used in the present description are defined by Roger S. Pressman, Ph.D, in his book, “SOFTWARE ENGINEERING: A Practitioner's Approach”, published by McGraw-Hill Book Company, in 1987, which book is incorporated herein by reference.

Also known in the art is a dimensional system for modeling emotion called Arousal-Valence-Control (AVC). (Dietz and Lang, 1999)

### SUMMARY OF THE INVENTION

In view of the foregoing disadvantages inherent in the known types of emotion simulators now present in the prior art, the present invention provides a system for modeling and simulating emotion states wherein the same can be utilized for simulating individual and group human emotion responses by data analysis of real-time or non-real time data.

To attain this, the present invention, in its broadest expression, includes (a) the Pleasure-Arousal-Dominance (PAD) table of emotions that makes it possible (b) to convert emotion terms to their respective PAD values, (c) a formula for working back from any specific set of PAD values to derive a single emotion term that best fits that particular combination of PAD values, (d) a formula for calculating the distance between a preselected set of PAD values and the closest emotion term that matches those PAD values, (e) a method for calculating the average emotional response of a group to any situation or stimulus, thereby permitting the derivation of a single emotion term that best represents the average emotional experience of the group. (f), a generic procedure for deriving emotion terms from multi-dimensional statistical models

In accordance with the invention, these and other objects are attained with a method for estimating an emotion term from a set of input PAD values, comprising the steps of:

(a) providing a set of input PAD values;

(b) for each emotion in a PAD table of emotions, calculating a distance Distanceᵢ between said set of input PAD values and an i^{th} record in a PAD table according to the following formula:

Distanceᵢ=\sqrt{|P−Pᵢ|²+|D−Dᵢ|²+|A−Aᵢ|²}

where P, A, D are the input PAD values, and Pᵢ, Aᵢ, Dᵢ, are the P, A, D values for record i,

(c) selecting the smallest value for Distanceᵢ; and

(d) converting the Pᵢ, Aᵢ, Dᵢ, value corresponding to the smallest value for Distanceᵢ into an emotion term.

The present invention also concerns a system for estimating an emotion term from a set of input PAD values comprising:

an input for receiving a set of input PAD values;

a PAD table of emotions, containing a plurality of records;

a calculator for calculating a distance between said set of input PAD values and an i^{th} record of said table;

a selector for selecting the record corresponding to the smallest distance between the input PAD values and the PAD values for the selected record;

a converter for converting the PAD values for the selected record into an emotion; and

an output for outputting said emotion.

In another aspect, the invention concerns a method for estimating a distance between a set of PAD values and an emotion term, comprising the steps of:

(a) providing a set of input PAD values;

(b) calculating a distance between said input PAD values and said emotion term;

(c) transforming said distance as a percentage; and

(d) outputting said distance and said percentage.

In yet another aspect, the invention concerns a system for estimating a distance between a set of PAD values and an emotion term, comprising:

an input for receiving said PAD values;

a calculator for calculating a distance between said input PAD values and said emotion term;

a transformer for transforming said distance into a percentage; and

an output for outputting said percentage.

The invention also concerns a method for converting a set of n input PAD values into a group emotion, comprising the steps of:

(a) inputting the input PAD values;

(b) calculating P_{avg}, A_{avg} and D_{avg}; and

(c) converting P_{avg}, A_{avg} and D_{avg} into an emotion.

In a similar vein, a system for converting a set of n input PAD values into a group emotion is provided, comprising:

an input for receiving the input PAD values;

a calculator for calculating P_{avg}, A_{avg} and D_{avg}; and

a converter for converting P_{avg}, A_{avg} and D_{avg} into an emotion.

In another aspect, the invention concerns a method for converting a set of n input PAD and AVC values into an emotion, term for the purpose of data conversion and using AVC statistics to infer “mood”, comprising the steps of:

(a) inputting input PAD values

(b) Converting AVC values into PAD values by first mapping them to PAD and then scaling each to the range from −100 to 100, mapping

A in AVC to A in PAD;

V in AVC to P in PAD;

C in AVC to D in PAD;

(c) calculating P_{avg}, A_{avg} and D_{avg}; and

(d) converting P_{avg}, A_{avg} and D_{avg} into an emotion term.

More specifically, a closed loop system adapted to achieve a desired state is proposed, the difference between the actual state of the system and said desired state being represented as an input P value, the input A value being the rate of change of the system and the input D value being how rapidly the system is achieving the desired state, wherein said system includes an output, said output being an emotion converted from the input P, A, D values.

Furthermore, a global terrain warning system for an airplane is also contemplated by the present invention, said system comprising inputs for monitoring height above ground level and converting the same to a P value, rate of change of altitude and converting the same to an A value and degree of corrective action and converting the same to a D value; a converter for converting the P, A and D values into an emotion; and a speech synthesizer adapted to reproduce speech based on said emotion.

In another practical aspect of the invention, there is provided a system for the simulation of human emotion in adventure game characters, simulated characters in a military simulation, or simulated-human agents by relating character goal achievement to P; speed of motion and/or urgency to A; ability to dominate a situation to D, along with a subsystem for weighting emotion tendencies, in order to simulate various emotion behaviour abnormalities, and to control character behaviour and appearance, when controlled by the resultant emotion term.

Finally, the invention concerns an open loop system for monitoring a state of said system, a difference between a set condition and a present condition being represented by a P value, a variability in said condition being represented as an A value, and a rate at which said present condition attains said set condition being represented as a D value, wherein said system further includes an output, said output being an emotion converted from the input P,A,D values.

Other objects and advantages of the present invention will become obvious to the reader and it is intended that these objects and advantages are within the scope of the present invention.

To accomplish the above and related objects, this invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

Various other objects, features and attendant advantages of the present invention will become fully appreciated, as the same becomes better understood when considered in conjunction with the accompanying drawings. The same or similar terms and abbreviations are used throughout all figures.

FIG. 1 (Prior Art) is an extract of the table of emotion-to-PAD values;

FIG. 2 (Prior Art) is a schematic representation of a simple lookup of PAD values of an emotion label;

FIG. 3 is a schematic representation of the conversion of PAD values to emotion labels and other values;

FIG. 4 is a schematic representation of the calculation of the distance from an input emotion to PAD values;

FIG. 5 is a schematic representation of the calculation of average PAD values;

FIG. 6 is a schematic representation of the PAD section;

FIG. 7 is a schematic representation of a thermostat including an emotion simulator according to a preferred embodiment of the invention;

FIG. 8 is a schematic representation of a Global Terrain Warning System including an emotion simulator according to another preferred embodiment of the invention; and

FIG. 9 is a schematic representation of a computer game including an emotion simulator according to another preferred embodiment of the invention.

### DESCRIPTION OF THE PREFERRED EMBODIMENT

The present invention provides a system for modeling and simulating emotion states wherein the same can be utilized for simulating individual and group human emotion responses by data analysis of real-time or non-real time data.

To attain this, the present invention includes (a) the Pleasure-Arousal-Dominance (PAD) table of emotions that makes it possible (b) to convert emotion terms to their respective PAD values, (c) a formula for working back from any specific set of PAD values to derive a single emotion term that best fits that particular combination of PAD values, (d) a formula for calculating the distance between a preselected set of PAD values and the closest emotion term that matches those PAD values, and (e) a method for calculating the average emotional response of a group to any situation or stimulus, thereby permitting the derivation of a single emotion term that best represents the average emotional experience of the group.

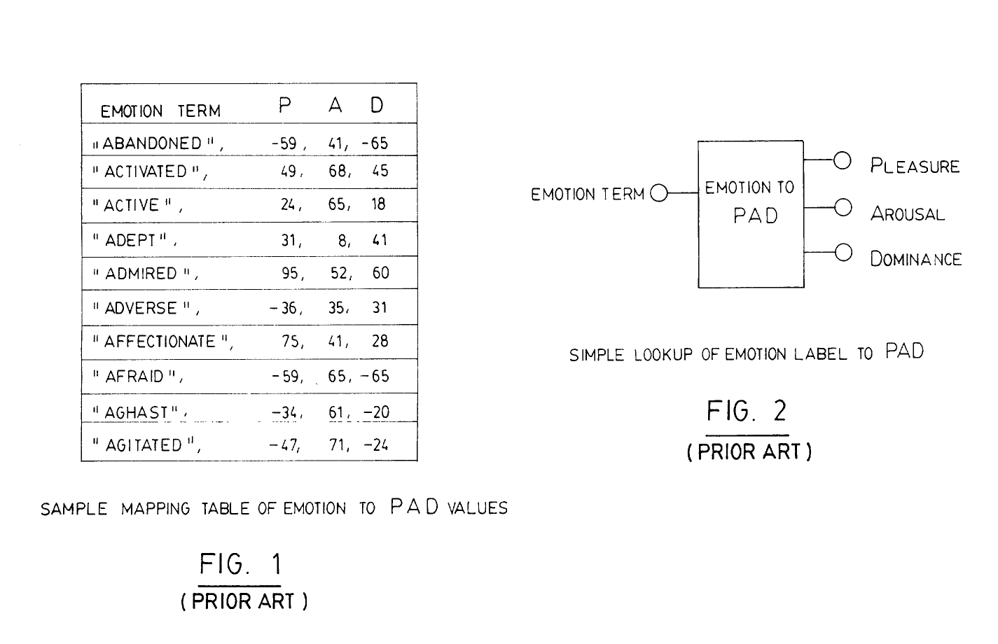

The Emotion to PAD converter has an emotion label as an input, and three output values representing varying degrees of pleasure (P), arousal (A), and dominance (D). The table allows one to convert the inputs (emotion terms) to outputs (PAD values). (see FIG. 2).

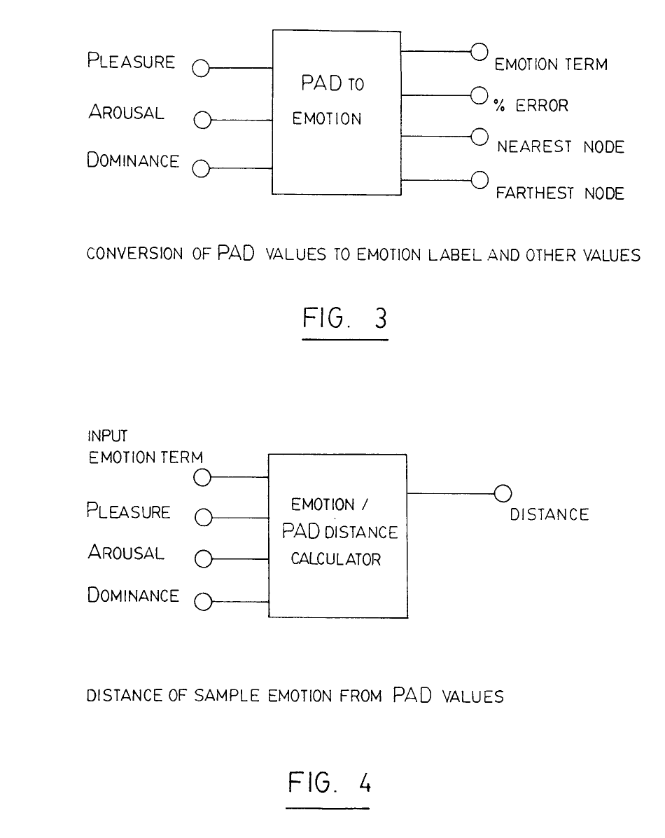

The PAD to Emotion converter has P, A and D numeric values as input, and an emotion label string as output. A conversion formula converts the numeric inputs into a string output (see FIG. 3), thus, in effect identifying an emotion term that best fits a specific combination of pleasure, arousal, and dominance values.

The Distance calculator estimates the similarity vs. difference between any given set of PAD values and any emotion term. The Distance calculator has four input values: P, A, D numeric values plus an emotion label string. The output is the Distance in emotion space between the specific P, A, and D values that are input and the exact location of the emotion term (the input string) in emotion space. The Distance is also expressed as a percentage figure. In sum, the Distance calculator converts the 4 inputs into the two outputs (see FIG. 4).

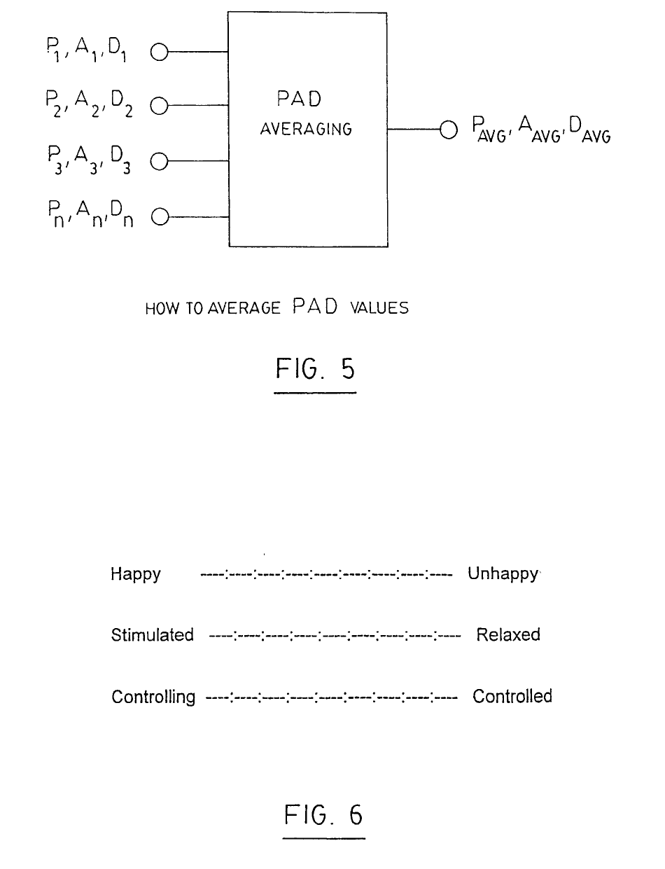

The PAD Averager can have from one to an infinite number of inputs. Each input consists of 3 numeric values: P, A, D. The outputs are Average P (i.e., average of all the P values), Average A (or average of all the A values) and Average D (average of all the D values) (see FIG. 5). In effect, the PAD Averager is used to identify the average emotional response of a group of individuals to any situation or stimulus. Once average P, A, and D values for a group are identified, the PAD to Emotion converter (FIG. 3) is used to assign an emotion term (or label) to that group emotion.

Because of the direct analogies which can be made between PAD and AVC data, the PAD averager can be used to average AVC data which is visually derived, with PAD data which is based on emotion terminology when appropriate scaling functions are used to convert AVC dimensions to the −100 to 100 scale.

The PAD table of emotions and the associated formulas for converting PAD values to specific emotion terms are used in the present invention to attribute human-like emotional expressions to mechanical and/or electronic control systems in industrial processes. To achieve this, various elements of a control system in an industrial process are first translated into P, A, and D values and then the PAD values are transformed into specific emotion terms. As a control system works to attain its stated objectives, some of its various elements will be in continuous flux and so will the P, A, and D values that are associated with those elements. These changing PAD values are continuously translated into emotion terms that become part of the output of the system. These emotion terms (or so-called “emotional expressions of the control system”) are then displayed to operators of the system via writing (e.g., on a computer monitor) or speech that is the byproduct of computer voice synthesis (i.e., computer-operated translations of emotion terms to speech). Based on such an output, appropriate action, if required, can be taken by the human operators.

In these respects, the system for modeling and simulation of emotion states incorporated in the present invention substantially departs from the conventional concepts and designs of the prior art, and in so doing provides an apparatus primarily developed for the purpose of simulating individual and group human emotion responses by data analysis of real-time or non-real time data.

Advantages of the present invention are to provide a system for modeling and simulating emotion states that:

Will overcome the shortcomings of the prior art devices.

Simulates individual and group human emotion responses by data analysis of real-time or non-real time data.

Accurately attributes an emotional state to each significantly different state of a data acquisition or data-reporting device or system, thus giving it human-like qualities.

Aids computer voice synthesis, textual and graphic display systems by providing an emotion parameter that can be used to affect their operations, that is based on real-time and non-real-time data analysis.

Calculates the average or median emotion of a group of people.

Given an emotion label, can represent that label as a point in 3-dimensional emotion space.

Provides the basic mathematics for representing interrelations among different emotions as points in 3-dimensional emotion space using PAD, AVC or any other statistically derived multi-dimensional emotion space.

Turning now descriptively to the drawings, in which similar reference characters denote similar elements throughout the several views, the attached figures illustrate a system and method for modeling and simulating emotion states, which comprises the derivation method for the PAD table of emotions, a formula for converting emotion terms to PAD values, a formula for comparing PAD values to derive a textual emotion term, a formula for calculating the distance between an emotion term and any set of PAD values, a formula for averaging PAD values.

The PAD Table of Emotions:

As mentioned in the Description of the Prior Art, the PAD table of emotions, a small section of which is shown in FIG. 1, provides precise descriptions (or measures) of 320 of the most common emotion terms by referencing each emotion term to three fundamental dimensions of emotional response: pleasure-displeasure (P), arousal-nonarousal (A), dominance-submissiveness (D). The PAD table of emotions contains 320 rows of data and is a database of information consisting of four fields as shown in FIG. 1. The first field is of String type and represents an emotion term (i.e., a label describing a specific emotion). The second field, labeled “P”, is numeric, with values that can range from −100 to +100, and indicates the degree of pleasure vs. displeasure that is associated with the emotion term given in the first field. The third field, labeled “A”, is numeric and can range from −100 to +100, and indicates the degree of arousal vs. nonarousal (defined as a combination of mental alertness and physical activity of an individual) that is associated with the emotion term given in the first field. The fourth field, labeled “D”, is numeric and can range from −100 to +100, and indicates the degree of dominance vs. submissiveness (defined as the feeling of control vs. lack of control an individual subjectively experiences) that is associated with the emotion term given in the first field.

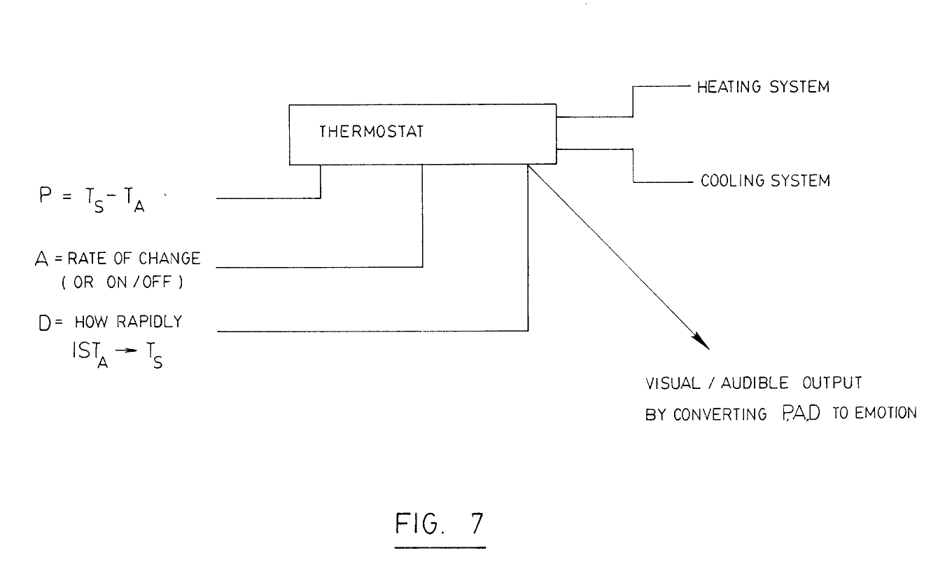

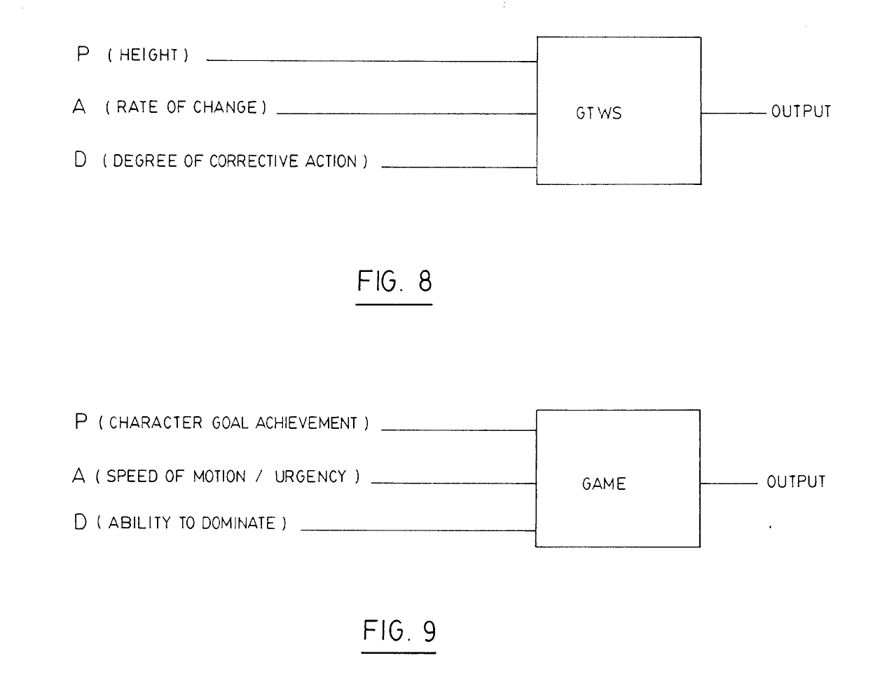

Pleasure (P), Arousal (A), and Dominance (D) values for each emotion term were derived using the PAD scales given in Table 4 of Mehrabian and Russell (1974), samples of which are given in FIG. 6. The Happy-Unhappy item in FIG. 6 is one of the six items of the Pleasure-Displeasure Scale. The Stimulated-Relaxed item in FIG. 6 is one of the six items of the Arousal-Nonarousal Scale. The Controlling-Controlled item in FIG. 6 is one of the six items of the Dominance-Submissiveness Scale. Thus, the PAD scales included a total of 18 items. Subjects were instructed to place a check mark in one of the nine spaces separating each pair of adjectives to show how they felt.

To obtain PAD values for a single emotion term (e.g., “angry”) at least 20 subjects were each individually presented the single word “angry” together with the PAD scales and were instructed to specifically describe how they feel when they are “angry” by placing a single check-mark on each of the 18 lines (items) of the scales. Check marks corresponding to the nine spaces, left to right were coded (translated) to scores ranging from +4 to −4, with the middle space coded as zero. The six coded scores for the six Pleasure-Displeasure items were summed, the six coded scores for the six Arousal-Nonarousal items were summed, and the six coded scores for the six Dominance-Submissiveness items were summed to obtain total Pleasure (P), Arousal (A), and Dominance (D) scores corresponding to “angry” for each subject. Pleasure scores of all subjects who rated the emotion term “angry” were then averaged. Similarly, Arousal scores of all subjects who rated the term “angry” were averaged and Dominance scores of all subjects who rated the term “angry” were averaged. This yielded consensus or group-based P, A, and D scores for the emotion term “angry”.

A similar experimental procedure was used to obtain group-based consensus P, A, and D scores for most commonly used emotion terms. Obtained ratings for the entire list of emotions were evaluated in relationship with one another and some were adjusted by Albert Mehrabian to highlight similarities and differences among the emotions and to enhance the production of distinct and vivid depiction of emotions in simulation and robotic applications. Also, in the final step, group-based consensus Pleasure scores were transformed linearly so they ranged from 100 to +100 (after rounding out). Similarly, group-based consensus Arousal and Dominance scores were also transformed linearly so they each ranged from −100 to +100 (after rounding out). The resulting group-based consensus Pleasure, Arousal, and Dominance formed the final list of 320 commonly used emotion terms that comprise the fully expanded version of the sample PAD emotion table given in FIG. 1.

PAD values for any other emotion term not contained among the 320 that are already rated can be obtained in the future by using the procedures detailed in the preceding three paragraphs. An alternative and more up-to-date set of PAD scales developed by Mehrabian (1995) is available and can be used for future assessments of PAD values of emotion terms. The latter scales include two optional methods: an Abbreviated set of PAD scales that includes 4 Pleasure items, 4 Arousal items, and 4 Dominance items (thus comprising a total of 12 items for the entire scale) or a Full-length set of PAD scales that includes 18 Pleasure items, 9 Arousal items, and 9 Dominance items (thus comprising a total of 36 items). Also, PAD values for any stimulus or situation (e.g., a facial expression on a computer screen, an image of two persons in conversation, a package design for a product, a computer software product) can be obtained using a similar set of procedures. In the latter instances, subjects will be asked to view the stimulus (e.g., the facial expression on a computer screen) and estimate how they feel by using items of the up-to-date set of PAD scales. When used in such applications, the Abbreviated PAD can be selected when subjects (respondents) cannot be expected to spend too much time describing their feelings. To obtain more accurate PAD assessments in critically important situations, the Full-length PAD scales can be used with subjects who may possibly be motivated with financial or other incentives to provide their ratings.

AVC—Arousal Valence Control

The AVC model has some similarities to the PAD model, and Arousal and Control are dimensional synonyms for Arousal and Dominance in the PAD Model. Valence however is the degree of attraction of likeability an individual feels towards an object. The statistical model for AVC is often derived by relating stimulating imagery to the three-dimensions AVC, but no emotion terms are used, other than in describing the dimensions themselves. Therefore, the work is imprecise in generating emotion terms. Where PAD statistics match emotion terms to P, A, D values, AVC statistics simply scatterplot the tendencies of their statistical model. The result is that for building simulation systems that involve non-verbal input using this invention, AVC data may sometimes be averaged with PAD data as a weighting system (this can be used for example, when simulating “mood”), but for systems that require accuracy in the emotion context, PAD data must be used.

For the purposes of simulation, the mathematics presented in this invention for averaging emotion values in a 3-dimensional PAD space have equivalents in a 3-dimensional AVC space. Therefore, it will be apparent to a person skilled in the art that AVC data may be used with several of the components of this invention including the PAD Averager, and Distance calculator.

In addition a two dimensional subset of AVC, Arousal-Valence, Valence-Control, or Arousal Control may be used in some embodiments of this simulation system by setting the missing dimension to a zero value.

The Emotion to PAD Converter:

The Emotion to PAD converter is a method and system that has an emotion label as an input, and three output values representing varying degrees of pleasure (P), arousal (A), and dominance (D). This converter can be, as will be appreciated by one skilled in the art, preferably embodied as a computer program. The table allows one to convert the inputs (emotion terms) to outputs (PAD values), as shown in FIG. 2. This is prior art insofar as it is based on the PAD emotion table described above. Converting an emotion string to its PAD values is performed by simple lookup function on the PAD Table where the key is the emotion label string and the results are the P, A and D values. If the Table is implemented in SQL, the statement would take the form: Select P, A, D Where EmotionName=<label>. If the table is implemented in a procedural or object oriented language, the table lookup is performed either by simple iteration through all table records, or if higher performance is desired, by selecting records that have been pre-sorted using a standard Quicksort or Hash Table algorithm.

The PAD to Emotion Converter:

The PAD to Emotion converter is a system and method that has P, A and D numeric values as inputs, and an emotion label string as an output. A conversion formula converts the numeric inputs into a string output (see FIG. 3), thus, in effect, identifying an emotion term that best fits a specific combination of pleasure, arousal, and dominance values.

Converting a set of P, A, D values to an emotion label is performed by first regarding the P,A,D values as a point in 3-dimensional space. Next, one iterates through all records and uses a 3 dimensional distance formula (see DISTANCE CALCULATION description) to determine the shortest distance in three-dimensional space between the P, A, D inputs and an emotion record contained within the PAD table. This is done by calculating the square root of ((P−Pi) squared)+(A−Ai) squared+(D−Di) squared)) where P, A, and D are the P, A, D input values and Pi, Ai, and Di are the PAD values for record i of the PAD Table. Using a process of iteration through all records of the PAD Table, a single record in the table is identified that has the smallest distance to the P, A, D values that constitute the input and the emotion label for that record is selected.

A supplementary technique uses the distance between the two “closest points” P, A, D and Pᵢ, Aᵢ and Dᵢ of the selected record to gauge an error factor and report it. Also, the distance of P−Pᵢ, A−Aᵢ, D−Dᵢ can indicate the direction that the emotion is offset. For example, if the emotion found via the PAD TO EMOTION procedure is “jittery”, but the P, A and D values are slightly off, an error output can indicate that the emotion is “jittery” plus or minus a Pₑᵣᵣₒᵣ, Aₑᵣᵣₒᵣ and Dₑᵣᵣₒᵣ. This error can be used by external software that interprets the emotion label to further qualify an emotion term.

The Distance Calculator:

The Distance calculator estimates the similarity vs. difference between any given set of PAD values and any emotion term. The Distance calculator has four input values: P, A, D numeric values plus an emotion label string. The output is the Distance in emotion space between the specific P, A, and D values that are input and the exact location of the emotion term (the input string) in emotion space. The Distance is also expressed as a percentage figure. In sum, the Distance calculator converts the 4 inputs into the two outputs (see FIG. 4).

The benefit of the distance formula (and related percentage figure) is that it allows one to ascertain how “far” a certain set of PAD values is from any given emotion label. Assume, for example, that one goal of a simulation system is to measure the “happiness” of the system. At each new stage (i.e., following the very last set of changes in the system) the system outputs its own PAD values and the distance between these system PAD values and PAD values for the term “happy” is computed, showing how far the system is at that stage from “happy.” In this way, for every new changed stage of the system, the distance measure becomes indicative of how removed the system is from “happiness.” The simulation model can be preset to output (e.g., via graphics, computer synthesized voice, or sounds) a distinct signal when the distance to happiness drops below a specified minimum, thereby indicating a satisfactory stage of the system; alternatively, when the distance measure exceeds a pre-specified maximum, the system can output a warning signal of dissatisfaction.

The PAD Averager:

The PAD Averager is a system and method that can have from one to an infinite number of inputs. Each input consists of 3 numeric values: P, A, D. The outputs are Average P (i.e., average of all the P values), Average A (or average of all the A values) and Average D (average of all the D values) (see FIG. 5). In effect, the PAD Averager is used to identify the average emotional response of a group of individuals to any situation or stimulus. Specifically, to average PAD values, one averages all of the P values from a group of respondents who have reported their emotional reaction to a specific situation or stimulus. Then one repeats this separately by averaging all their A values for the same situation or stimulus. Next, one repeats this separately by averaging all their D values for that same situation or stimulus. Once average P, A, and D values for a group are identified, the PAD to Emotion converter (FIG. 3) is used to assign an emotion term (or label) to that group emotion.

Alternatively, instead of averages, median P, median A, and median D scores may be used in some cases where there is a concern about a handful of very extreme PAD scores resulting in excessive error in calculations of averages.

Applications to Closed Loop Industrial Control Systems:

In applying our invention to any industrial control system, we use human emotional function as a metaphor to describe the various states of a control system. Our method of analyzing an industrial process or system to determine appropriate P, A and D values for the process or system is an important aspect of this invention. There are two types of control systems whose data we can process into PAD representations. The first type is “a closed loop” system; the second is an “open loop system”.

In a closed loop system, there usually is a “desired state” that is achieved by adjusting a control parameter (e.g., a setpoint, setting, limit, or range, or any parameter that indicates the desired state of a system). For example, this desired state for a home heating system is the temperature level set with a thermostat. The degree to which the state of the system achieves that “desired state” is indexed as the Pleasure level of the system—the greater the differential between desired and achieved state, the lower the Pleasure level of the system. In the example of home heating system, the absolute difference in temperature of the room vs. the temperature setting of the thermostat becomes the Pleasure level of the system. No elaborate mathematics are required. The degree to which a system can or cannot achieve its desired state is mapped linearly to a value from −100 to 100 so that these values in turn correspond to Pleasure values in the PAD emotion table.

To determine the Arousal level of a system, we calculate the rate of change of the system from one sampling time to the next. A weight factor is determined so that maximum rate of change multiplied by this weight factor=100 and minimum rate times this factor=−100. A different function for weight factor is used when the rate of change is completely non-linear or another method of determining arousal is required. Another way of determining arousal in a simple control system like a thermostat is to increase the arousal value every time the system comes on, and decrease it every time the system goes off. In this case, we use a maximum top value of 100 and a bottom-most value of −100. The definition of Arousal level can change from system to system, but the basic idea is that whatever causes a system to change rapidly, exert greater effort, and/or make numerous adjustments over time will be scored as heightening the Arousal level of the system. In contrast, anything that causes a system to relax, become inactive, or to decrease its rate of change is scored as lowering the Arousal level of the system. For example, some computer CPU (central processing unit) chips go into a stand-by mode when power is not required. This is a low arousal state. When the chip leaves stand-by mode and returns to full power, this is a high arousal state.

To determine the Dominance level of a “closed loop” control system, we determine how rapidly the system is achieving its objectives. Psychologically, an important ingredient of feelings of dominance is power or strength; conversely, submissiveness includes weakness. Translated to industrial and mechanical situations, then, an important way in which dominance is indexed is in terms of the power (e.g., horsepower, BTU) of the system. A system that has a lot of power and achieves its set-point or objective quickly is indexed as being more dominant; one that is perhaps malfunctioning and in need of repair and achieves its set-point slowly is indexed as being low in dominance. For example, a thermostat that causes a refrigerator to cool by turning on a cooling pump and achieves the cooling rapidly is indexed as being dominant (“in control”). If the cooling pump is turned on and the resulting temperature decrease is very slow (possibly because the system is malfunctioning or because someone has left several doors and windows open), then the system is indexed as being submissive. In sum, then, in a simple closed loop situation, dominance is the rate at which the control system succeeds in achieving its goal. This of course needs to be weighted to provide a value between −100 and 100.

It is our theorem that any time the above rules are followed in a closed loop situation, the resultant P, A, D values when mapped to emotion labels will closely mimic the emotion response that a human operator who might be manually operating such a system would feel.

Applications to Open Loop Industrial Control Systems:

In an “open loop” situation where a set point or control factor is not specified and a process is simply monitored, dominance can still be measured as described for closed loop situations. The difference is interpretive, because the system is not controlling, but simply monitoring what is happening. An example of this would be a stock monitor. Pleasure would be indicated by the difference between the actual stock price and the target price; arousal would be indicated in terms of variability of stock price over time. Thus, one might compute the standard deviation of stock prices sampled every 15 seconds during each hourly period. Higher standard deviations would increase the Arousal level (i.e., the subjective experience of alertness and physical activity of the monitor). For Dominance level, one would compare the rate at which the difference between target price and actual stock price is decreasing. If this rate is rapid (i.e., the actual stock price quickly approaches the target price), then dominance is high; if the rate is slow or if the actual stock price moves further away from the target price, then dominance is low and submissiveness is high.

The main components can be configured in different orders to achieve different goals. There are several intended connections of the main components that have practical uses, though there are theoretically an infinite number of possible connections between the components depending on system size and goal.

The first way to connect the components is to simply use the PAD to Emotion component on it's own to take sample P, A and D inputs and derive an emotion. A device like a simple thermostat with an emotion display could be built using only this component.

The second is to use the EMOTION to PAD component to allow a user to select an emotion labels and interpret the emotion in terms of a PAD value.

The third is to connect several devices that generate P, A, D values through the PAD averager and derive a “group” emotion. Monitoring the overall emotion of a multi-step process could be achieved in this manner.

The fourth is to connect multiple EMOTION to PAD components to allow many users to select emotion labels, then average these with the PAD averager. Finally connect this output PAD value to a PAD to EMOTION component and the result emotion label will represent the emotion tendencies of the group, as a whole.

The fifth is to connect a controlled process that generates PAD values to the Distance Calculation with an emotion label as the secondary input and calculate the distance between a target emotion and a sampled emotion. This can be used in a control system where a particular emotion is the desired goal of the system. In this case, decreased distance would indicate that the system was successful. For example, if a system's goal was to be “relaxed”, which implies low A values, high P values and moderate or low D values, the system could, using this fifth method show greater success when the sampled PAD values were closer to that emotion. Emotion labels used by and generated by the various components can be used as input to text-to-speech systems that have been programmed to modulate voice according to an emotion term.

It is possible to “thin” (remove records from) or “increase” (add records to) the number of emotions available in the table of PAD values in order to better tune the system to act appropriately for a particular application. For example, the system can be used with a jet global terrain warning system, which speaks warning messages to the pilot such as “pull up”, or “terrain warning”. This system would require a small subset of the over 300 emotion terms available with PAD, to influence the voice system to make it represent the situation more accurately. In this system, which concerns itself only with warnings, those emotions that would help the pilot comprehend the situation better such as “fear”, “anger”, and “alert”, would be chosen in preference to non-relevant emotions such as “love”.

The operation of the software depends on its target platform and use. The invention, when embodied as computer software, can be written or rewritten in any procedural or object-oriented computer language, and run on any computer operating system, that is capable of storing the PAD table and executing the methods previously described.

The present invention can be used to create systems that simulate or mimic human emotion, or that desire to use the database of human emotion to control a system. Typically such a system requires an input stimulus and an output emotion term.

The invention can also be used to derive “group” or “averaged” emotion. Each component exists as one or more classes in one of these formats that can be instantiated by appropriate calling procedures. The components can be used together, and configured in any combination, but the most common uses would be the connections described previously. The actual usage and operation of the software, depends on which specific components are chosen in order to solve a particular emotion-related problem.

In a typical embodiment designed to aid computer voice synthesis, textual or graphic display systems, by providing an emotional parameter that would be used to affect their operations, the present invention can be used to control a closed-loop system, as previously described.

The steps are to begin by analyzing the system to determine what system states, sensory readings or combination of readings would constitute “pleasure”, and develop a linear mapping for those values in a range from −100 to 100, then assign that to the P input of a PAD to EMOTION converter. For example, in a simple thermostat, “pleasure” might be defined as “the degree to which the setpoint matches the actual temperature”, and mapped to a range of −100 to 100.

Then, the system is analyzed in terms of Arousal, as previously described, and assign that value in a range from −100 to 100 to the A input. For example, a thermostat could exhibit enhanced arousal when measured temperature values changed rapidly, or, alternatively, when the control system required rapid change. Similarly, a Dominance factor would be derived based on how rapidly the system is achieving its objectives. The greater the systems ability to control itself, the greater the D value would be set, in a range from −100 to 100.

Using the formula previously described, regarding the PAD to Emotion converter, the algorithm would find the “nearest” emotion term, among all emotion records in the PAD Table of Emotions.

Some emotions in the table can be ignored if their emotion terms are inappropriate to the type of emotion simulation desired, by removing them from the search.

The output emotion terms can serve as input to a text-to-speech synthesizer which can use the emotion term to alter pitch envelope, timbre envelope and volume envelope of sentences to better model a human voice's emotion content.

The emotion term can be used in artificial intelligence systems that simulate human conversation to specify the “context” by which the conversation focus is altered. For example, an emotion system built using our system that reacted to weather data, might tend to relate more pleasant emotion terms on sunny days than cloudy, which could be used to specify the emotional context of the Artificial Intelligence software, allowing intelligent software agents to be created that converse as if effected by these emotions.

A similar system can be built to enhance Global Terrain Warning Systems, used in many jet airplanes. Many Terrain Warning systems uses a voice synthesizer to speak advisory phrases such as “Terrain Warning, Terrain Warning” to a pilot, though these systems do not speak the phrases in an emotion-filled manner. The addition of emotion to such a system could be used to enhance the speech synthesizer by relating data on the aircraft data bus.

For example in a scenario where a Terrain Warning system was monitoring altitude above terrain, Pleasure (P) can be derived by the height above the ground level (AGL), with lower pleasure the closer to the ground. Arousal (A) can be directly keyed to rate of descent, with increased arousal with increased rate of descent. Dominance can be keyed to the rate at which corrective action is succeeding. If the pilot is in a stupor and hasn't reacted to the warnings, Dominance will be low. If the pilot is reacting quickly, and the plane is gaining altitude, Dominance will be higher.

The PAD values are entered into the PAD to EMOTION converter as input, on scaled from −100 to 100 and the resultant emotion would then be used to inflect the speech synthesizer. This would give the pilot added aural input to indicate the degree of emergency and allow him or her to clock at which stage of the emergency they were in. The emotion term can also be used in aircraft simulator software to simulate the emotion of a second crewmember, a useful tool for cockpit management training.

A system to derive an emotion term from weather data, to be used by pilots to improve their safety by simulating what their emotions “should be” due to weather, can use METAR (Aviation Routine Weather Report) reports in conjunction with TAF (Terminal Area Forecast) data which is widely available in ASCII computer format, to derive P, A and D Values.

The Arousal (A) value can be mapped to the rate at which weather conditions are changing, with more diversity over a time period increasing Arousal. The Pleasure (P) value can be assigned to derive a scale of pleasure from −100 to 100 using various combinations of METAR values such as CAVOK (Conditions OK) and TSR (Thundershowers) to create a pleasure scale. The (D) values can be mapped to the rate at which previous TAF (Terminal Area Forecast) reports accurately mapped to current conditions, with high dominance indicating that forecasts are getting increasingly accurate over time, and low dominance indicating increasing lack of correlation over time.

Pilots are notorious for flying into bad weather and ignoring their own emotions. The end result PAD would be used as input to the PAD to EMOTION converter to derive an emotion that would reflect what a pilot “should” feel and report it.

A system to determine an “average” emotion would use the PAD Averager to take the PAD values from multiple open or closed loop systems to determine an average PAD value that could be used as input to the PAD to Emotion Converter.

If a group of humans were to “vote” on their emotions, for example, in a focus group examining a product, their votes would concern their “emotion” at using or viewing a product. They would “vote” for a particular emotion, and each vote would be converted to PAD values using the EMOTION to PAD Converter, then averaged using the PAD Averager to derive an average PAD Value. This PAD value could be further converted back into an emotion term using a PAD to EMOTION converter. Thus, the result of several humans voting on emotional terms would be a new emotional term that reflects the emotional tendencies of the group as a whole.

By using the Distance Calculator, which takes an emotion term and a sample PAD value as inputs, the groups emotion could be compared to the PAD values from each voters emotion, so that the distances from the resultant emotion could be gauged, to determine if any particular voter's emotion is so far away from the median that the value should be discarded, to trigger a “recount” that removes that voters input from the equation, improving accuracy.

The invention can be used by software developers developing computer simulated actors or characters in computer adventure games, and actor or character simulations in a military simulation.

In this embodiment, individual characters in the game can be represented as data objects that contain an “emotion term” field. This field would be calculated using the PAD to Emotion term calculator to interpret P, A, D values that are based on a character's situation in the game. In this case, the P value is determined on a sliding value from −100 to 100 representing the characters success in achieving the goals of the game or a specific context within the game, the A value is determined either by the rate at which the situational parameters are changing, by the speed of motion of the character, or alternatively by the urgency of the current situation. For example, a character who is about to be attacked in a surprise attack, might suddenly have the A value raised to 100 at the time when the attack begins. Or, the character in a chase scene might be moving rapidly around a 3-d simulated world, thus elevating the A value, or not moving which would lower the A value. The D value can be calculated by evaluating the rate at which the character is succeeding in achieving a goal, or by evaluating a character's relative strength in comparison to the strength of an immediate adversary to determine the level to which the character is “in control” of the situation.

Psychological tendencies for individual characters can be simulated by weighting the P, A and D inputs in a specific direction. For example, constant agitation can be simulated by fixing Arousal at 100. Depressive tendencies can be simulated by leaving the D value near −100. Using the PAD Averager, weights can be added easily by picking finding P, A and D values that represent the emotion tendency that is desired, then averaging the “live” PAD values with that fixed “tendency” PAD value. Weights can be used to simulation psychotic behaviour, depression, anxiety and a host of other psychological ailments.

The resulting emotion term of the above character emotion simulation can be used in conjunction with commonly used scripting techniques to control facial expression, character behaviour, and plot direction.

As to a further discussion of the manner of usage and operation of the present invention, the same should be apparent from the above description.

Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

Although the present invention has been explained hereinabove by way of a preferred embodiment thereof, it should be pointed out that any modifications to this preferred embodiment within the scope of the appended claims is not deemed to alter or change the nature and scope of the present invention.

1. A method for estimating an emotion term from a set of input PAD values, comprising the steps of:
(a) providing a set of input PAD values;
(b) for each emotion in a PAD table of emotions, calculating a distance Distanceᵢ between said set of input PAD values and an i^{th} record in a PAD table according to the following formula:
Distanceᵢ=\sqrt{|P−Pᵢ|²+|D−Dᵢ|²+|A−Aᵢ|²}
where P, A, D are the input pad values, and Pᵢ, Aᵢ, Dᵢ, are the P, A, D values for record i,
(c) selecting the smallest value for Distanceᵢ; and
(d) converting the Pᵢ, Aᵢ, Dᵢ, value corresponding to the smallest value for Distanceᵢ into an emotion term:

2. A method according to claim 1, wherein said method further includes the step of outputting an error factor, comprising the steps of:
(e) calculating Pₑᵣᵣₒᵣ=(P−P₁), Aₑᵣᵣₒᵣ=(A−Aᵢ) and Dₑᵣᵣₒᵣ=(D−Dᵢ) for the smallest value of Distanceᵢ; and
(f) outputting Pₑᵣᵣₒᵣ, Aₑᵣᵣₒᵣ and Dₑᵣᵣₒᵣ.

3. A system for estimating an emotion term from a set of input PAD values comprising:
an input for receiving a set of input PAD values;
a PAD table of emotions, containing a plurality of records;
a calculator for calculating a distance between said set of input PAD values and an i^{th} record of said table;
a selector for selecting the record corresponding to the smallest distance between the input PAD values and the PAD values for the selected record;
a converter for converting the PAD values for the selected record into an emotion; and
an output for outputting said emotion.

4. A system according to claim 3, wherein said system further includes an error calculator for calculating an error factor between said input PAD values and the PAD values for the selected record.

5. A method for estimating a distance between a set of PAD values and an emotion term, comprising the steps of:
(a) providing a set of input PAD values;
(b) calculating a distance between said input PAD values and said emotion term;
(c) transforming said distance as a percentage;
(d) outputting said distance and said percentage.

6. A system for estimating a distance between a set of PAD values and an emotion term, comprising:
an input for receiving said PAD values;
a calculator for calculating a distance between said input PAD values and said emotion term;
a transformer for transforming said distance into a percentage; and
an output for outputting said percentage.

7. A method for converting a set of n input PAD values into a group emotion, comprising the steps of:
(a) inputting the input PAD values;
(b) calculating P_{avg}, A_{avg} and D_{avg};
(c) converting P_{avg}, A_{avg} and D_{avg} into an emotion.

8. A method according to claim 7, wherein in said step (b), calculating P_{avg}, A_{avg} and D_{avg} includes calculating P_{median}, A_{median} and D_{median}.

9. A system for converting a set of n input PAD values into a group emotion, comprising:
an input for receiving the input PAD values;
a calculator for calculating P_{avg}, A_{avg} and D_{avg}; and
a converter for converting P_{avg}, A_{avg} and D_{avg} into an emotion.

10. A system according to claim 9, wherein said calculator also calculates P_{median}, A_{median} and D_{median}.

11. A method for converting a set of n input PAD and AVC values into an emotion, term for the purpose of data conversion and using AVC statistics to infer “mood”, comprising the steps of:
(a) inputting input PAD values
(b) Converting AVC values into PAD values by first mapping them to PAD and then scaling each to the range from −100 to 100, mapping
A in AVC to A in PAD;
V in AVC to P in PAD;
C in AVC to D in PAD;
(c) calculating P_{avg}, A_{avg} and D_{avg};
(d) converting P_{avg}, A_{avg} and D_{avg} into an emotion term

12. A closed loop system adapted to achieve a desired state, the difference between the actual state of the system and said desired state being represented as an input P value, the input A value being the rate of change of the system and the input D value being how rapidly the system is achieving the desired state, wherein said system includes an output, said output being an emotion converted from the input P, A, D values.

13. A system according to claim 12, wherein said system is a heating/cooling system, where P is the difference between the set temperature and the actual temperature, A is whether or not the system is on, and D is how rapidly the system is achieving the set temperature.

14. A global terrain warning system for an airplane, said system comprising inputs for monitoring height above ground level and converting the same to a P value, rate of change of altitude and converting the same to an A value and degree of corrective action and converting the same to a D value; a converter for converting the P, A and D values into an emotion; and a speech synthesizer adapted to reproduce speech based on said emotion.

15. A system for the simulation of human emotion in adventure game characters, simulated characters in a military simulation, or simulated-human agents by relating character goal achievement to P; speed of motion and/or urgency to A; ability to dominate a situation to D, along with a subsystem for weighting emotion tendencies, in order to simulate various emotion behaviour abnormalities, and to control character behaviour and appearance, when controlled by the resultant emotion term.

16. An open loop system for monitoring a state of said system, a difference between a set condition and a present condition being represented by a P value, a variability in said condition being represented as an A value, and a rate at which said present condition attains said set condition being represented as a D value, wherein said system further includes an output, said output being an emotion converted from the input P,A,D values.
